(19) United States
(12) Patent Application Publication
(10) Pub. No.: US 2007/0046054 A1
(43) Pub. Date: Mar. 1, 2007

(54) Interior trim accessory attachment apparatus

(76) Inventors: David Toliaferro Hinman, Highland, MI (US); Daniel Torres, Clarkston, MI (US); Brian Christopher Miscovich, Bruce Township, MI (US)

Correspondence Address: YOUNG & BASILE, P.C., 3001 WEST BIG BEAVER ROAD, SUITE 624, TROY, MI, 48084, US

(21) Appl. No.: 11/216,920

(22) Filed: Aug. 31, 2005

(51) Int. Cl. B60J 9/00

(52) U.S. Cl. 296/1.07

(57) ABSTRACT

An apparatus and method for mounting an accessory article in a vehicle interior using a clip to which the article is attached and which is mounted through an aperture in a vehicle body part. Deformable force applying ribs are disposed between the clip and the accessory and are deformed upon tightening of the fastener drawing the clip and the accessory closer together. The ribs exert a biasing force against the clip to prevent movement of the clip and the accessory with respect to the vehicle body part while drawing the clip into fixed, non-movable engagement with the vehicle body part. The ribs may be integrally molded as part of the accessory or formed on a separate member mountable between the accessory and the clip.

### BACKGROUND

The present invention relates, in general, to accessory attachment mounts for vehicle interiors.

Attachment of interior vehicle accessories, such as trim, coat hooks, assist handles, sun visor center supports, etc., use metal or metal and plastic clips which snap into apertures in vehicle body panels or structure through a headliner, door trim, etc. Screw fasteners as threaded into the clip to attach the accessory to the clip.

In a layer build vehicle interior assembly process, all interior components are assembled one at a time onto the vehicle in the vehicle final assembly plant. This is time consuming which adds cost to the vehicle. In addition, repetitive work injuries to assembly workers frequently occurs from the positions such workers must assume within the interior of the vehicle to attach threaded fasteners and clips to the vehicle roof, doors, dashboard, etc.

To reduce vehicle manufacturing costs, modular interior assembly techniques have been devised. In a modular vehicle interior assembly process, all accessories, such as coat hooks, assist handles, etc., are mounted on the headliner, door, etc., at the subassembly facility. This enables the entire headliner, door trim, etc., to be attached to the vehicle in the final assembly plant in a single operation via clips. The threaded fasteners used to attach the accessories though the headliner or door panel to the clips are preattached to the clips by the sub assembly manufacturer. This modular assembly process reduces repetitive work injuries since the vehicle interior component is completely assembled outside of the vehicle in a more convenient work position. In addition, assembly time in the vehicle assembly plant is reduced since the entire headliner, door trim panel, etc., can be snapped into the vehicle in a quick, simple operation.

In both layer or modular build assembly processes, the clips must be designed with a low insertion force required to angularly deform or bend the movable portions of the clip inward during insertion of the clip through the aperture in a vehicle body panel or support. At the same time, the clip design and/or clip material must be selected so as to provide a high pull-out force so as to remain securely attached to the vehicle after assembly. However, manufacturing tolerances in the clip, vehicle body panel, accessory, etc., create dimensional differences which lead to undesirable looseness of the clip and the attached accessory in the vehicle body.

Thus, it would be desirable to apply a vehicle trim interior accessory attachment apparatus which simplifies the assembly and mounting of vehicle interior accessories within a vehicle. It would also be desirable to provide a vehicle trim interior accessory attachment apparatus which can be easily inserted into a vehicle while still providing high pull-out forces as well as providing tight, non-movable attachment of the clip and the accessory to the vehicle body.

### SUMMARY

An apparatus and method for mounting an accessory article, such as an interior trim accessory, in a vehicle interior.

In one aspect of an attachment apparatus, a clip is provided with flexible flaps which allow the clip to pass through an aperture in a vehicle body part to secure the clip to the vehicle body part. An accessory article is attached to the clip by a fastener. Force applying means are disposed between the article and the clip for fixedly, substantially non-movably mounting the article in the clip in the vehicle body part as the fastener is further tightened with respect to the clip.

In one aspect, the fastener is a threaded screw. The article includes a throughbore for extension of the screw through the article and aperture in the clip.

The force applying means, which can be in the form of one or more deflectable ribs, can be fixedly attached to the accessory article or in the form of a separate member disposed between the clip and the article.

In another aspect, a method is disclosed for attaching an article to a vehicle interior body part. The method comprises the steps of:

attaching an article to a clip by a fastener;

inserting the clip through an aperture in the vehicle body part to secure the clip and the article to the vehicle body part;

and then further engaging the fastener with the clip to deform deformable members disposed between the clip and the article into biased engagement between the clip and the article to substantially non-movably fix the clip and the article with respect to the vehicle body part.

The accessory attachment apparatus of the present invention overcomes deficiencies found with previously devised attachment apparatus or clips used to attach accessories, such as vehicle trim pieces or other articles to a vehicle interior.

The force applying means deployed between the clip and the article, once deflected or deformed upon further tightening of the fastener used to attach the article to the clip, exerts a biasing force against the clip to securely and substantially non-movably fix the clip and the attached article to the vehicle body part. This eliminates any play in the mounting of the clip in the vehicle body part which may result in the feel of undesirable looseness in the article attachment.

The present attachment means may be employed with any vehicle interior trim buildup method, including a layer build or a module build process. The attachment apparatus and method may be employed with many different vehicle interior trim articles.

### BRIEF DESCRIPTION OF THE DRAWING

The various features, advantages and other uses of the invention will become more apparent by referring to the following detailed description and drawing in which:

FIG. 1 is a perspective view of one aspect of a vehicle interior trim accessory attachment apparatus;

FIG. 2 is a bottom view of the clip shown in FIG. 1;

FIG. 3 is an end view of the clip shown in FIG. 1;

FIG. 4 is a side elevational view of the clip shown in FIG. 1 showing a partially assembled position of the apparatus;

FIG. 5A is a cross-sectional view generally taken along line 5-5 in FIG. 1;

FIG. 5B is a cross-sectional view, similar to FIG. 5A, but depicting a final assembly position of the interior trim attachment apparatus;

FIG. 6 is a cross-sectional view generally taken along line 6-6 in FIG. 1;

FIG. 7 is a bottom perspective view showing the clip mounted in a vehicle body panel;

FIG. 8 is a top perspective view of one aspect of a vehicle interior trim accessory mountable by the clip in a vehicle;

FIG. 9 is a top perspective view of another aspect of a vehicle interior trim accessory mountable by the clip shown in FIG. 1 in a vehicle;

FIG. 10 is a perspective view of another aspect of the vehicle interior trim accessory attachment apparatus; and

FIG. 11 is a perspective view of a modification to the apparatus shown in FIG. 10.

### DETAILED DESCRIPTION

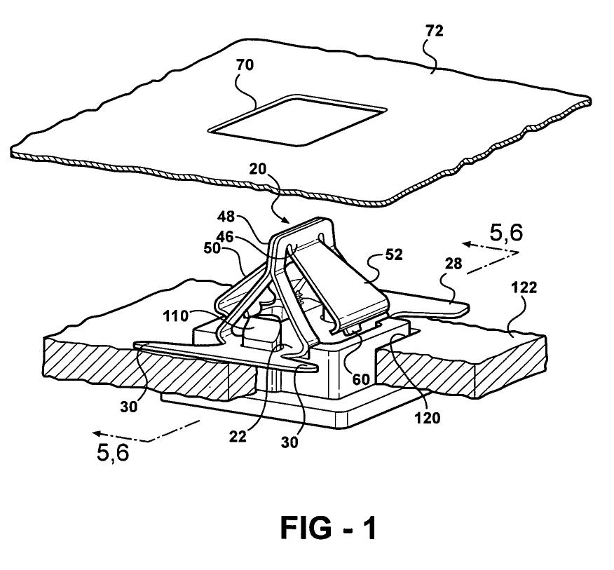

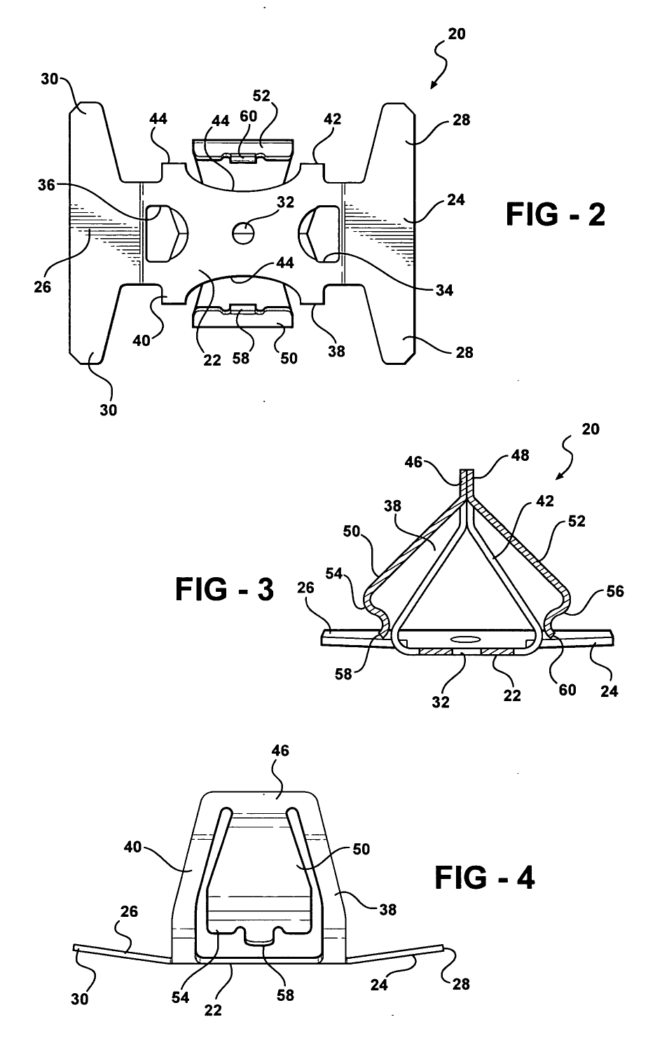

Referring now to the drawing, and to FIGS. 1-8, there is depicted one aspect of a vehicle interior accessory mounting apparatus.

The apparatus includes a clip 20 which may be formed as a one piece, bent member formed of a spring material, such as spring steel. Joined assemblies of separate components of metal, plastic, or combinations thereof, may also be employed to form the clip 20.

The clip 20 includes a generally planar base 22 from which two end extensions 24 and 26 oppositely extend. The end extensions form T-shaped members with respect to the base 22 by means of oppositely extending tabs 28 and 30. The tabs 28 and 30 extend laterally outward beyond the side edges of the base 22.

A generally centrally located aperture 32 is formed in the base 22 and is adapted for receiving a threaded fastener, as described hereafter. A pair of generally D-shaped apertures 34 and 36 are formed in the base 22 on opposite sides of the central aperture 32. The D-shaped apertures 34 and 36 are adapted for mounting over or receiving guide posts on an accessory to properly orient the clip 20 with the accessory, as described and shown hereafter.

An upper portion of the clip 20, projecting from the base 22, is generally symmetrical by formed with two pairs of sides, including a first pair of sides 38 and 40 and a second pair of sides 42 and 44. Each of the sides 38, 40, 42, and 44 extends in a generally arcuate or curved manner from the base 22 to top ridge 46 for the first pair of sides 38 and 40 and top ridge 48 for the second pair of sides 42 and 44. The top ridges 46 and 48 join each pair of sides 38 and 40, and 42 and 44 into a rigid structure.

One lateral flap 50 and 52 extends from each top ridge 46 and 48, respectively, toward the base 22. The lateral flaps 50 and 52 also have an arcuate shape extending from an end joined to the top ridges 46 and 48 to a lower end 54 and 56, respectively. Lower tabs 58 and 60 depend from the lower ends 54 and 56, respectively. The tabs 58 and 60 are freely movable with respect to the base 22 and the remainder of the clip 20.

Referring to FIG. 1, the clip 20 is mountable through an aperture 70 in a vehicle body or vehicle body support panel 72. The aperture 70 may have any shape, although a generally square or other polygonal shape is depicted by way of example only.

In a headliner application of the clip 20, the support 72 is in the form of a plate fixedly attached to the vehicle body, such as a roof rail, or roof panel. For assist handles mounted on vehicle pillars, the support 72 may be the roof pillar itself.

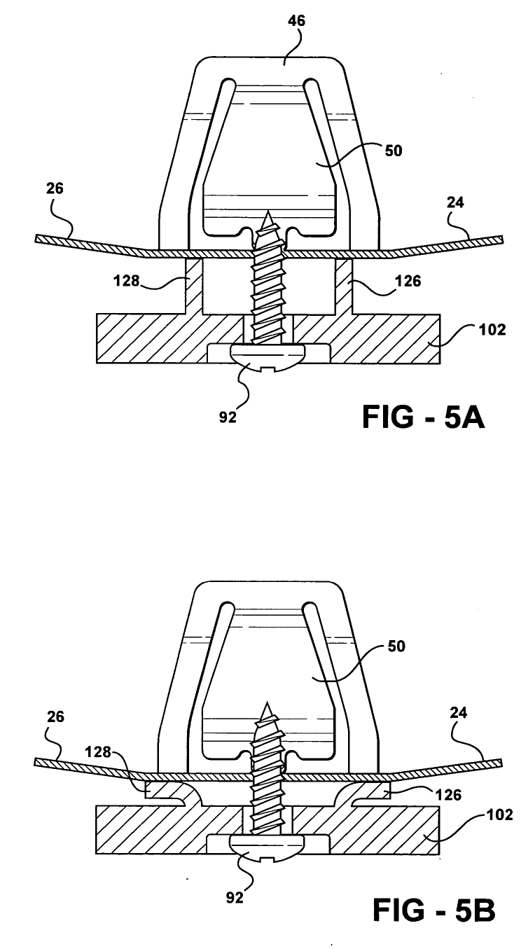

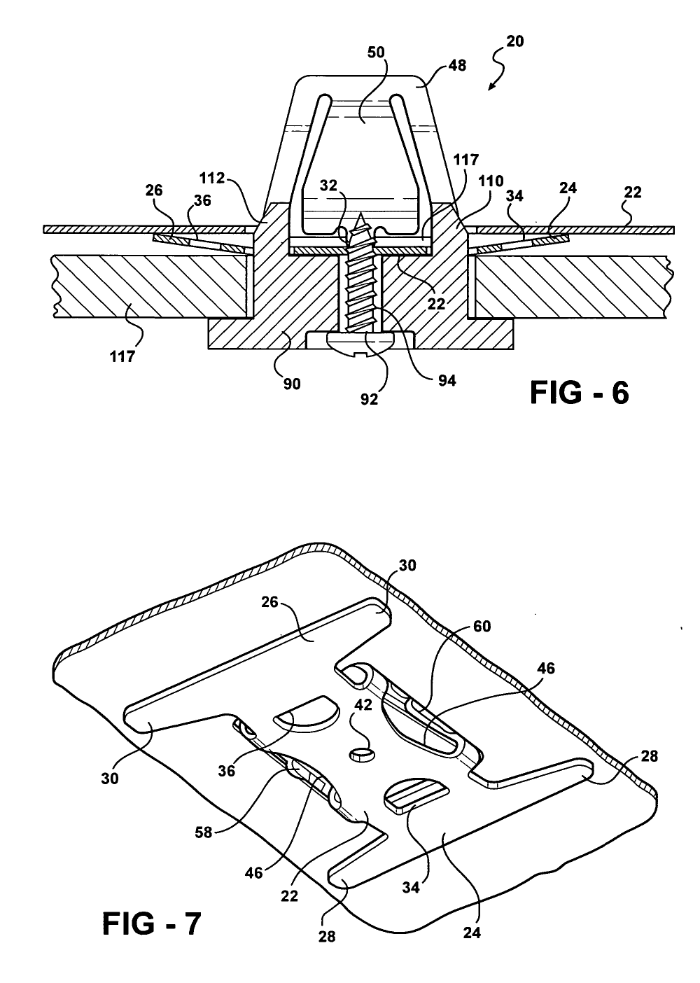

As shown in FIGS. 5 and 6, the clip 20 can be inserted through the aperture 70 in the support 72. During engagement of the flaps 50 and 52 with the edges of the support 72 surrounding the aperture 70, the insertion force causes the flaps 50 and 52 to bend inward from their normal, outwardly spaced position to a narrower dimension allowing the upper portion of the clip 20 to pass through the aperture 70.

Insertion of the clip 20 continues until the tabs 58 and 60 on the flaps 50 and 52 are disposed adjacent the inner edges of the aperture 70. At this time, the flaps 50 and 52 expand outward to their normal spaced position as shown in FIG. 5A to fix the clip 20 to the support 72.

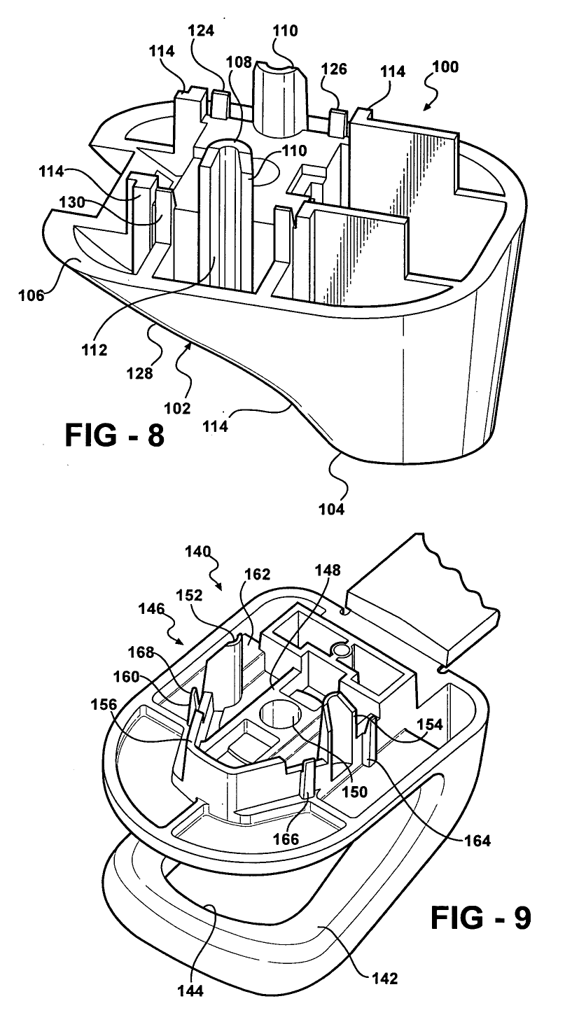

A vehicle accessory article 90, which may have, in one aspect, the shape shown in FIG. 8, is fixedly secured to the clip 20 by means of a fastener, such as a threaded fastener 92 shown by way of example only in FIGS. 5A, 5B and 6. The fastener 92 extends through a bore 94 in the accessory 90 and the central aperture 32 in the base 22 of the clip 20.

Referring now to FIG. 8, there is depicted one example of an accessory 100 which may use the clip 20 for mounting on a vehicle interior panel.

It will be understood that the description of the following example of the coat hook accessory 100 will be by way of example only as any other accessory, such as assist handles, etc., may also be used.

The coat hook 100 includes a body 102 having a lower hook 104 depending and spaced from an upper surface of 106. A base 108 is located generally centrally within the periphery of the upper surface 106. The base has a bore 110 extending therethrough which opens exteriorly of the body of the coat hook 100.

At least one or more guideposts, with two guideposts 110 and 112 being shown by way of example only, are formed on the body 102 on opposite sides of the base 108. The guideposts 110 and 112 have a shape complementary to the shape of the D-apertures 34 and 36 in the clip 20 so as to position the clip 20 in the proper orientation with respect to the base 108.

In addition, support members, with four support members 114 being shown by way of example only, are also formed on the body 102 of the coat hook 110 generally at opposite corners of the base 108. The supports 114 also function to orient the clip 20 in the proper orientation with respect to the base 108 as well as to the clip 20 on the base 108. The supports 114 engage peripheral surfaces of the base 22 of the clip 20.

In the illustrated example of a coat hook 100, in either a layer or a modular assembly process, the clip 20 is inserted through an aperture 120 in a vehicle headliner 122. The coat hook 100 is secured to the clip 20 by the fastener 92 which extends through the bore 110 in the body 102 of the coat hook 100 as shown in FIGS. 5 and 6. The attachment of the coat hook 100 to the clip 20 occurs after the upper portion of the clip 20 has been inserted through the headliner 122. This causes the headliner 122 to be trapped between the coat hook 100 and the base extensions of the clip 20.

In order to eliminate any play or sloppiness and to cause the coat hook 100 to be fixedly and substantially non-movably secured to the clip 20 and to fix the clip 20 in a substantially non-movable manner within the aperture 70 and the vehicle support panel 72 are, force applying means are disposed between the coat hook 100 and the clip 20. The force applying means may include one or more deformable ribs, with four ribs 124, 126, 128, and 130 being shown by way of example only. The ribs 124, 126, 128, and 130 form post like extensions which are integrally formed in the body 102 and normally project outwardly from the upper surface of the base 108 as shown in FIG. 8.

As shown in FIG. 5A, which depicts an initial modular assembly position at the headliner assembly facility, the fastener 92 secures the coat hanger 100 to the clip 20 with the base 22 of the clip 20 resting on the upper edge of each of the deformable ribs 124, 126, 128, and 130. In this position, the clip 20, the coat hanger 100, and the headliner 122 are fixedly secured together.

To mount the entire headliner assembly in the vehicle at the vehicle assembly plant, the clip 20 is inserted through the aperture 70 in the vehicle support panel 72. With the headliner 122 supported in its final mounting position within the vehicle, the fastener 92 is further tightened to draw the base 108 of the coat hanger 100 further toward the base 22 of the clip 20. This causes the ribs 124, 126, 128, and 130 to laterally deform with respect to the base 102 to the deformed position shown in FIG. 5B. In this position, the base 22 of the clip 20 may be in substantial contact with the upper surface of the base 108. However, the deformed or bent ribs 124, 126, 128, and 130 exert a biasing force against the base 22 of the clip 20 which holds the clip 20 in a fixed, substantially non-movable position against the support 72 of the vehicle. This fixedly secures the coat hanger 100 to the vehicle in a substantially non-movable manner with little, if any play or movement.

Another example of an accessory 140 which may employ the clip 20 is shown in FIG. 9. The accessory 140 also is a coat hanger having a lower substantially U-shaped lip 142 which forms an aperture 144 for receiving one end of a coat hanger. The remainder of the body 146 of the accessory 140 forms a structure spaced from the lip 142. A base 148 with a through bore 150 is formed in the body 146. At least one or more guideposts, with two guideposts 152 and 154 being shown by way of example only, are formed on the body 146 in opposed spaced positions with respect to the base 148. A wall 156 is formed in the body 146 and extends completely around the periphery of the base 148. By way of example only, the upper surface of the wall 156 projects further from the body 146 than the upper surface of the base 148.

This construction places the upper surface of the base 148 in a recessed position below the upper surface of the wall 156. The inner surface of the wall 156 thus forms a receptacle or means for properly positioning and fixing the clip 120 within the body 146.

The guideposts 152 and 154 engage the D-shaped apertures 34 and 36 in the base 22 of the clip 20 to properly orient the clip 20 with respect to the body 146.

Force applying means, in the form of four deformable ribs 160, 162, 164, and 166 shown, by example only, are unitarily formed on the body 146 adjacent to or as extensions of the wall 156. An upper surface 168 of each of the ribs 160, 162, 164, and 166 projects from the upper surface of the adjacent portion of the wall 156.

The ribs 160, 162, 164, and 166 function in the same manner as the ribs 124, 126, 128, and 130 described above in that the upper surface 168 of each of the ribs 160, 162, 164, and 166 engages and supports the base 22 of the clip 20 in an initial mounting position, similar to that shown in FIG. 5A, when the coat hanger 140 is inserted through an aperture in the headliner 122 and fixed to the clip 20 by the fastener 92 extending through the bore 150 in the base 148. At the final assembly of the headliner assembly 122 into the vehicle, after the clip 20 has been seated through the aperture 70 in the vehicle support panel 72, the fastener 92 is further tightened to cause the ribs 160, 162, 164, and 166 to deform laterally from the base 148. This allows the base 22 of the clip 20 to substantially contact and seat on the base 148 of the body 146.

At the same time, the ribs 160, 162, 164, and 166 exert a biasing force on the clip 20 to substantially non-movably fix the clip 20 with respect to the vehicle support 72 as well as to fix the coat hanger 140 with respect to the clip 20 to substantially eliminate any play or movement of the coat hook 140 with respect to the surrounding portions of the vehicle.

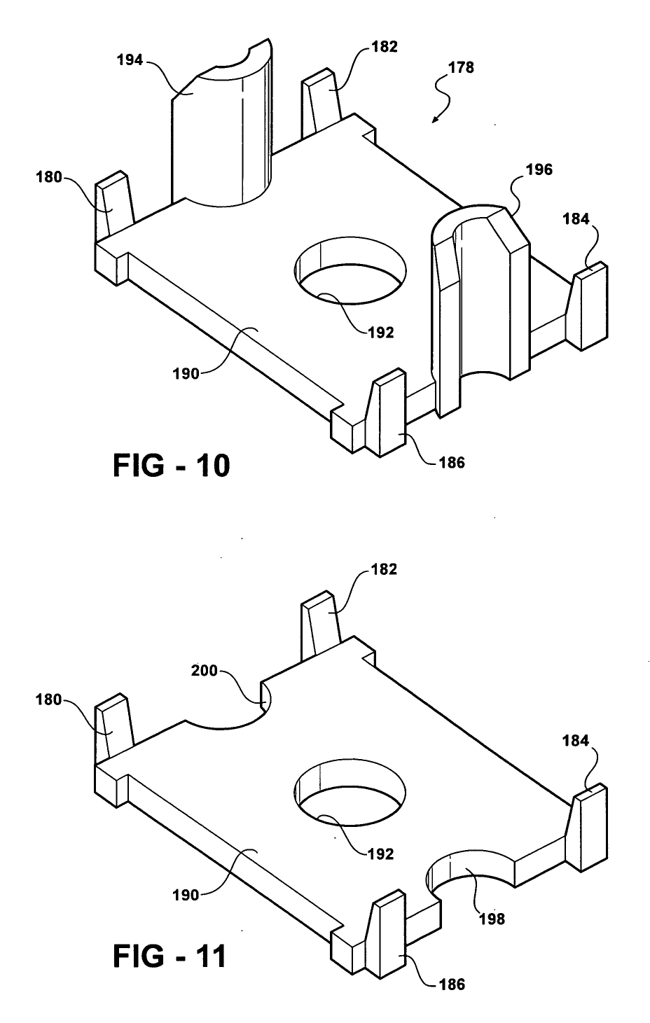

Another aspect of a vehicle accessory attachment apparatus 178 is shown in FIG. 10. In this aspect, a plurality of deformable ribs, with four ribs 180, 182, 184, and 186 shown by example only, are formed on a generally planar washer or disc 190. The disc 190 is sized and shaped to seat on a flat upper surface of one of the bases 108 or 148 with a throughbore 192 in the washer 190 aligned with the throughbore 110 or 150 in the bases 108 and 148, respectively. The apparatus 178 enables the deformable ribs 180, 182, 184, and 186 to be mounted on an existing vehicle accessory without requiring modification of the accessory to provide the advantage of the deformable means or ribs 180, 182, 184, and 186 to existing accessories.

In the aspect shown in FIG. 10, the washer 190 supports one or more guideposts 194 and 196. The guideposts 194 and 196 enable engagement of the washer 190 with the clip 20 to properly orient the washer 190 and the clip 20 with respect to the accessory 100 or 140, by example only. The provision of the guideposts 194 and 196 on the washer 190, which may be formed by unitary molding with the washer 190, eliminates the need for adding guideposts to the body of the accessory 100 or 140. This enables the proper orienting features to be applied to an existing vehicle accessory.

It will understood that the guideposts 194 and 196 may not be provided on the washer 190 as shown in FIG. 11. Instead, either of the pairs of guideposts 110 and 112 or 152 and 154 shown in FIGS. 8 and 9 may be unitarily formed on the body of the accessory 100 or 140 and engaged by recesses 198 and 200 on opposed sides of the washer 190.

What is claimed is:

1. An accessory attachment apparatus for vehicle interiors for attaching an accessory article to a vehicle body part having an aperture comprising:
a clip with flexible flaps allowing the clip to pass through an aperture in a vehicle body part to secure the clip to the vehicle body part;
an accessory article;
a fastener engaged with the clip to secure an article to the clip; and
force applying means, disposed between the article and the clip, for fixedly, substantially non-movably mounting the article and the clip in the vehicle body part as the fastener is further tightened with respect to the clip.

2. The apparatus of claim 1 wherein the clip further comprises:
a base; and
opposed extensions extending from the base.

3. The apparatus of claim 1 wherein:
the fastener is a threaded screw; and
the article includes a throughbore for extension of the screw through the article and an aperture in the clip.

4. The apparatus of claim 1 wherein the vehicle body part includes a vehicle support panel mounted adjacent the vehicle roof.

5. The apparatus of claim 1 wherein the force applying means is carried by the article.

6. The apparatus of claim 1 wherein:
the force applying means is fixedly attached to the accessory article.

7. The apparatus of claim 1 wherein:
the force applying means includes a separate member disposed between the clip and the article.

8. The apparatus of claim 7 further comprising:
at least one guidepost carried on the article and engageable with the clip for orienting the clip with respect to the accessory article.

9. The apparatus of claim 1 further comprising:
at least one guidepost carried on the accessory article and engageable with the clip for orienting the clip with the respect to the accessory article.

10. The apparatus of claim 1 wherein the force applying means comprises:
at least one bendable rib projecting from a body of the accessory article.

11. The apparatus of claim 1 wherein the force applying means comprises:
a plurality of deformable ribs projecting from a body of the accessory article.

12. A method for attaching an article to a vehicle interior body part comprising the steps of:
attaching an article to a clip by a fastener;
inserting the clip through an aperture in the vehicle body part to secure the clip and the article to the vehicle body part; and then further engaging the fastener with the clip to deform members disposed between the clip and the article into biased engagement between the clip and the article to substantially non-movably fix the clip and the article with respect to the vehicle body part.
